(19) United States
(12) Patent Application Publication
(10) Pub. No.: US 2011/0054111 A1
(43) Pub. Date: Mar. 3, 2011

(54) ENCAPSULATED TINTERS

(75) Inventors: Fiona McLachlan, London (GB); Martin W. Murray, Guisborough (GB)

(73) Assignee: AKZO NOBEL COATINGS INTERNATIONAL B.V., Arnhem (NL)

(21) Appl. No.: 12/936,310

(22) PCT Filed: Apr. 1, 2009
(86) PCT No.: PCT/EP09/53858

§ 371 Date: Nov. 15, 2010

(30) Foreign Application Priority Data
Apr. 4, 2008 (GB) 0806057.6
May 14, 2008 (GB) 0808734.8

(51) Int. Cl. C09D 129/04

(52) U.S. Cl. 524/543

(57) ABSTRACT

The invention provides a tinter dosage unit comprising water borne tinter encapsulated in a water soluble pouch where the water activity of the tinter and the combined water activity and plasticizer activity of the pouch are such that the pouch remains intact in normal use.

This invention relates to water borne tinters encapsulated in a water soluble pouch, a process for their preparation and methods for their use.

Broadly speaking, the decorative coatings market can be regarded as falling into two categories: the ready-mix market where the coating products are supplied ready mixed, colour being added at the point of manufacture, and the tinted market, where colour is added at the point of purchase or point of use.

By coating products is meant products in the nature of paints, distempers, varnishes and stains which can be applied to a surface to alter its colour or texture. The water dispersible tinters of this invention are intended for use in making tinted coating products which are tinted at the point of sale or at the point of use.

In-store tinting comprises adding to a base paint, one or more pigment containing tinters according to a recipe to produce a particular pre-determined colour. The tinters comprise a dispersion of one or more pigments in a liquid carrier. For water borne paints the carrier will be aqueous. The base paint can be either a standard white paint or a base paint particularly formulated for tinting.

Tinting is normally carried out in-store using a computer controlled tinting machine.

However, in some markets professional painters and decorators and some consumers prefer to tint the paint by hand on site prior to application. When tinting in this way, the tinters, normally liquid tinters, are poured into the base paint according to a pre-determined recipe or by eye to produce the required colour. Tinting in this way is subject to significant batch to batch variations. Tinting dosage units have been proposed in the past including tinting dosage units containing water borne tinters but to date none have been made to work in practice. We have now discovered that it is possible successfully to formulate such tinters when the water activity of the tinter balances the combined water and plasticizer activity of the film.

Accordingly the present invention provides a tinter dosage unit comprising water borne tinter encapsulated in a water soluble pouch where the water activity of the tinter and the combined water activity and plasticizer activity of the pouch are such that the pouch remains intact in normal use.

In practice the pouch may be formed from a water soluble polymer film.

A broad range of water soluble polymer films can be used in the preparation of the pouch within which the water borne tinter is encapsulated. The main criterion is the water activity of the tinter and the combined water activity and plasticizer activity of the film are such that the pouch remains intact in normal use. “In normal use” in this context means that the pouch is robust enough to be filled on an automated filling line, to be shipped, to be storage stable in a trade or retail distribution chain and to withstand use by tradesmen and consumers.

Examples of suitable films include polyvinyl alcohols, polyvinyl acetates, polyvinyl pyrrolidones, poly carboxylic acids and their salts, polyacrylates, polyacrylamides, cellulose, cellulose ethers, cellulose esters, cellulose amides, polyacrylic acids and their salts, polyaminoacids and peptides, polyamides, copolymers of maleic and acrylic acids, polysaccharides.

Particular examples are polyacrylates, water soluble acrylate copolymers, a polyvinyl alcohol or a polyvinyl alcohol copolymer and especially a water soluble a polyvinyl alcohol film.

When the polymer is cellulose, it can be methyl cellulose, carboxymethyl cellulose sodium, ethyl cellulose, hydroxyethyl cellulose, hydroxypropyl methylcellulose or maltodextrin.

The water activity of the tinter and the combined water and plasticizer activity of the pouch give a measure of the mechanical stability of the pouch in the final product. Water activity (Wa) is a measure of the energy status of water in the system and is defined by the vapour pressure of water in the gas equilibrium with the system divided by that of the vapour pressure of pure water at the same temperature. Water activity can be measured by standard methods.

For the film, the combined water and plasticizer activity is best measured indirectly from the force necessary to puncture the film after it has been in contact with the tinter. It is calculated from the ratio of the force necessary to rupture the film upon its having been in contact with the tinter to the force necessary to rupture the untreated film.

For the tinters of the present invention, water activity can be in the range 0.1 to 1.00 inclusive. Generally it is 0.2 or above, for example 0.3, 0.4, or 0.6. Generally it will not be above 0.9 so it can be for example 0.6, 0.7 or 0.8.

The combined water and plasticizer activity of the film can be from 20 to 110% inclusive. Examples of minima for this range are 25, 30, 35, and 40%. Examples of maxima are 100, 90, 80 and 70%. A particular range is from 40 to 90%.

Generally speaking the film will contain a plasticizer, for example polyethylene glycol, polypropylene glycol and propylene triol.

The thickness of the film will depend on the chemical nature of the film and the use to which the tinter dosage unit is to be put and will be determined on a case by case basis using routine experimentation.

For example the thickness can be as low as 15 μm or as high as 100μ. Examples of minima for the rage of thicknesses are 20, 30 and 40 μm. Examples of maxima are 60, 70 and 80 μm. Examples of ranges are 20 to 75 μm and 25 to 50 μm.

Water soluble films suitable for making the pouches of the present invention are known and are commercially available for example as HiSelon from Nippon Gohsei, Solublon PVAL KC50 and KA 50 from AICELLO and Monosol M7031, M8670 and PXP6829 from Monosol LLC.

The tinters for use in the present invention may comprise one or more coloured pigments and optionally one or more filler pigments, one or more humectants, one or more dispersants and other minor components for example one or more wetting agents, a biocide a preservative and an antifoam agent.

### Examples of Pigments for Use in the Tinters of the Present Invention Include:

### Organic Pigments for Example:—

### Monoazo Pigments:

C.I. Pigment Brown 25; C.I. Pigment Orange 5, 13, 36, 38, 64 and 67; C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4, 63, 112, 146, 148, 170, 175, 184, 185, 187, 191:1, 208, 210, 245, 247 and 251; C.I. Pigment Yellow 1, 3, 62, 65, 73, 74, 97, 120, 151, 154, 168, 181, 183 and 191; C.I. Pigment Violet 32;

### Disazo Pigments:

C.I. Pigment Orange 16, 34, 44 and 72; C.I. Pigment Yellow 12, 13, 14, 16, 17, 81, 83, 106, 113, 126, 127, 155, 174, 176 and 188;

### Disazo Condensation Pigments:

C.I. Pigment Yellow 93, 95 and 128; pigments: C.I. Pigment Red 144, 166, 214, 220, 221, 242 and 262; C.I. Pigment Brown 23 and 41;

### Anthanthrone Pigments:

C.I. Pigment Red 168;

### Anthraquinone Pigments:

C.I. Pigment Yellow 147, 177 and 199; C.I. Pigment Violet 31;

### Anthrapyrimidine Pigments:

C.I. Pigment Yellow 108;

### Quinacridone Pigments:

C.I. Pigment Orange 48 and 49; C.I. Pigment Red 122, 202, 206 and 209; C.I. Pigment Violet 19;

### Quinophthalone Pigments:

C.I. Pigment Yellow 138;

### Diketopyrrolopyrrole Pigments:

C.I. Pigment Orange 71, 73 and 81; C.I. Pigment Red 254, 255, 264, 270 and 272;

### Dioxazine Pigments:

C.I. Pigment Violet 23 and 37; C.I. Pigment Blue 80; flavanthrone pigments: C.I. Pigment Yellow 24;

### Indanthrone Pigments:

C.I. Pigment Blue 60 and 64;

### Isoindoline Pigments:

C.I. Pigments Orange 61 and 69; C.I. Pigment Red 260; C.I. Pigment Yellow 139 and 185;

### Isoindolinone Pigments:

C.I. Pigment Yellow 109, 110 and 173;

### Isoviolanthrone Pigments:

C.I. Pigment Violet 31;

### Metal Complex Pigments:

C.I. Pigment Red 257; C.I. Pigment Yellow 117, 129, 150, 153 and 177; C.I. Pigment Green 8;

### Perinone Pigments:

C.I. Pigment Orange 43; C.I. Pigment Red 194;

### Perylene Pigments:

C.I. Pigment Black 31 and 32; C.I. Pigment Red 123, 149, 178, 179, 190 and 224; C.I.

Pigment Violet 29;

### Phthalocyanine Pigments:

C.I. Pigment Blue 15, 15:1, 15:2, 15:3, 15:4, 15:6 and 16; C.I. Pigment Green 7 and 36;

### Pyranthrone Pigments:

C.I. Pigment Orange 51; C.I. Pigment Red 216;

### Pyrazoloquinazolone Pigments:

C.I. Pigment Orange 67; C.I. Pigment Red 251;

### Thio Indigo Pigments:

C.I. Pigment Red 88 and 181; C.I. Pigment Violet 38;

### Triarylcarbonium Pigments:

C.I. Pigment Blue 1, 61 and 62; C.I. Pigment Green 1; C.I. Pigment Red 81, 81:1 and 169; C.I. Pigment Violet 1, 2, 3 and 27; C.I. Pigment Black 1 (aniline black); C.I. Pigment Yellow 101 (aldazine yellow); C.I. Pigment Brown 22.

### Inorganic Colour Pigments for Example:

White pigments: titanium dioxide (C.I. Pigment White 6), zinc white, pigment grade zinc oxide; zinc sulphide, lithopone;

Black pigments: iron oxide black (C.I. Pigment Black 11), iron manganese black, spinel black (C.I. Pigment Black 27); carbon black (C.I. Pigment Black 7);

Chromatic pigments: chromium oxide, chromium oxide hydrate green; chrome green (C.I. Pigment Green 48); cobalt green (C.I. Pigment Green 50); ultramarine green; cobalt blue (C.I. Pigment Blue 28 and 36; C.I. Pigment Blue 72); ultramarine blue; manganese blue; ultramarine violet; cobalt violet; manganese violet; red iron oxide (C.I. Pigment Red 101); cadmium sulfoselenide (C.I. Pigment Red 108); cerium sulphide (C.I. Pigment Red 265); molybdate red (C.I. Pigment Red 104); ultramarine red; brown iron oxide (C.I. Pigment Brown 6 and 7), mixed brown, spinel phases and corundum phases (C.I. Pigment Brown 29, 31, 33, 34, 35, 37, 39 and 40), chromium titanium yellow (C.I. Pigment Brown 24), chrome orange; cerium sulphide (C.I. Pigment Orange 75); yellow iron oxide (C.I. Pigment Yellow 42); nickel titanium yellow (C.I. Pigment Yellow 53; C.I. Pigment Yellow 157, 158, 159, 160, 161, 162, 163, 164 and 189); chromium titanium yellow; spinel phases (C.I. Pigment Yellow 119); cadmium sulphide and cadmium zinc sulphide (C.I. Pigment Yellow 37 and 35); chrome yellow (C.I. Pigment Yellow 34); bismuth vanidate (C.I. Pigment Yellow 184).

Lustre pigments: platelet-shaped pigments having a monophasic or polyphasic construction whose colour play is marked by the interplay of interference, reflection and absorption phenomena including aluminium platelets and aluminium, iron oxide and mica platelets bearing one or more coats, especially of metal oxides.

Such pigments are commercially available, for example, from BASF, Clariant, Ciba, Degussa, Elementis and Rockwood.

As mentioned above, the tinters of the present invention may also contain a filler pigment. A filler pigment is a substance which has pigment-like properties but has little or no affect on the Hue. Used at higher levels, it may have a dilution effect on the colour appearance, resulting in a perceived reduction in the Saturation (colour intensity), or an increase in the Lightness of the sample. Examples of inorganic pigments typically used as fillers are aluminium oxide, aluminium hydroxide, aluminium silicate, barium sulphate, calcium carbonates particularly precipitated chalk, clays, transparent silicon dioxide, ground quartz, natural micas and zinc sulphate. In particular the filler may be barium sulphate.

The amount of filler pigment employed in any particular composition depends primarily upon the colour required in the final tinter. That will be a matter of taste and the proportion of filler pigment to coloured pigment will be adjusted accordingly. The precise amounts for any particular tinter can be determined by routine experimentation.

Examples of humectants for use in the present invention are polyethylene glycol, polypropylene glycol and polypropylene triol and complex esters for example glycerol triacetate. In particular it can be polyethylene glycol especially polyethylene glycol 400. Where the tinter contains a humectant, it may be present in an amount of from 2 to 20% by weight inclusive of the tinter, and especially up to 4.0, 5.0 or 6.0% by weight.

The tinters of the present invention can also contain one or more surfactants or dispersing agents. The surfactant can be non ionic or ionic. Where it is ionic, it may be present in an amount of from 1 to 15% by weight inclusive of the tinter. An example of a dispersing agent is Bermodol. An example of an ionic surfactant is Nuosperse. The tinter may also contain other ingredients such as an antifoam and a biocide.

The tinter also contains water to make the formulation up to 100%

The tinters of the present invention can be made by standard methods for example by mixing the ingredients in a mixing vessel until the mixture is homogeneous. The maximum solids content for tinters of the present invention is 80% by weight of tinter. The tinter so obtained can be filled into a pouch and sealed.

The tinter dosage units of the present invention can be made by or by analogy with known processes. So a ready made water soluble pouch of the present invention is filled with a ready made tinter and closed to be liquid tight. Alternatively, a pouch of the present invention is filled with a part complete tinter and the remaining components are added to the pouch and mixed to make up the finished tinter.

The tinters themselves can be made in a two stage process. In the first stage some or all of the components that go to make up the tinter are mixed to form wetted premix and any remaining components are subsequently added individually or as additional premixes forming a pigment dispersion.

The mixing steps can be carried out using a variety of equipment for example high speed dispersers, dissolvers, ball mills, bead mills, roll mills, sand mills and extruders.

The tinter pouches can themselves be made by known processes. For example where the pouch is made from a film, a sheet of film can be folded double and sealed on two of the three open edges. The remaining open edge can be sealed once the pouch has been filled.

In systems of the type disclosed here, there is the possibility for interactions between the components of the tinter themselves and the components of the tinter and the pouch. Hence the components of the tinter have to be chosen to be compatible with components of the pouch. The tinters must satisfy all of the requirements of point of sale liquid tinter for use with a water based paint. The pigment must for example be stabilised and stable and be readily dispersible in the base paint employed. Factors taken into account here are water content, rheology, extender content and the production processing conditions. All of these factors can be determined by known methods.

For example the extenders used can be chosen bearing in mind that polydispersity is an important factor in achieving a high solids composition and to minimise the amount of liquids materials (water and potential plasticizers) required for effective processing and so minimising potential interactions with the polymer pouch.

The tinter dosage units of the present invention can be prepared in volume or weight units that would be convenient to end users for example 10, 20, 30, 50, 100, 250 and 500 g or 10, 20, 30, 50, 100, 250 and 500 ml quantities.

In use the tinter dosage units of the present invention can be added according to either a predetermined recipe or by eye to a white paint or to a base paint to produce paint to the desired colour.

As well as solving the problem of how to make a water borne tinted paint using a tinter dosage unit comprising a water borne tinter in a water soluble pouch, it also provides the benefit of providing a low to zero volatile organic solvent content (VOC), a goal long sought after by paint manufacturers until today with no real success.

The following Examples illustrate the invention. Quantities are expressed in weight percent

| Component | Chemical Name | Example 1 | Example 2 | Example 3 | Example 4 |
|---|---|---|---|---|---|
| | Water | 4.00 | 4.00 | 3.00 | 14.00 |
| Humectant | Polypropylene Glycol 600 | — | 5.00 | — | 13.00 |
| | Polyethylene Glycol 600 | 15.00 | — | 5.00 | — |
| Non ionic | Fatty acid ethanolamide | 3.00 | 7.00 | 7.00 | 3.00 |
| (Dispersant) | | | | | |
| Dispersant | Soya Lecithin | 0.00 | 0.00 | 4.00 | — |
| Anionic | Fatty acid (phosphoric)modified | 1.00 | — | — | 5.00 |
| (Wetting | ester | | | | |
| agent) | Fatty acid modified ester | — | 5.00 | 1.00 | — |
| Preserving | 1-(3-CHLOROALLYL)357- | 0.10 | 0.10 | 0.10 | 0.10 |
| Agent | TRIAZA1AZONIDAMANTANE | | | | |
| Antifoam | Polysiloxane | 0.20 | 0.20 | 0.20 | 0.20 |
| Pigment | TiO2 | 76.70 | 78.70 | 79.70 | 64.70 |
| | (Pigment White 6) | | | | |
| | Average Force (N) test sample | 21.49 | 23.12 | 15.77 | 10.25 |
| | Average Force (N) Blank | 22.43 | 22.43 | 20.83 | 21.51 |
| | Force N as % blank | 95.81 | 103.08 | 75.71 | 47.65 |

| Component | Chemical Name | Example 7 | Example 8 | Example 9 |
|---|---|---|---|---|
| | Water | 7.00 | 7.00 | 7.00 |
| Humectant | Polyethylene Glycol 600 | 15.00 | 9.00 | 5.00 |
| Non ionic | Fatty acid ethanolamide | 3.00 | 3.00 | 7.00 |
| (Dispersant) | | | | |
| Dispersant | Soya Lecithin | 4.00 | — | 4.00 |
| Anionic | Fatty acid (phosphoric)modified | 5.00 | 1.00 | 5.00 |
| (Wetting | ester | | | |
| agent) | | | | |
| Preserving | 1-(3-CHLOROALLYL)357- | 0.10 | 0.10 | 0.10 |
| Agent | TRIAZA1AZONIDAMANTANE | | | |
| Antifoam | Polysiloxane | 0.20 | 0.20 | 0.20 |
| Pigment | Yellow Iron Oxide | 39.70 | 39.70 | 71.70 |
| | (Pigment Yellow 42) | | | |
| Filler Pigment | Barium Sulphate | 26.00 | 40.00 | — |
| | Average Force (N) test sample | 16.50 | 13.21 | 12.45 |
| | Average Force (N) Blank | 25.05 | 25.05 | 25.05 |
| | Force N as % blank | 65.87 | 52.73 | 49.70 |

| Component | Chemical Name | Example 5 | Example 6 |
|---|---|---|---|
| | water | 11.33 | 10.05 |
| Humectant | Polyethylene Glyco1600 | 5.13 | 4.55 |
| Non ionic | Fatty acid ethanolamide | 5.13 | 8.08 |
| (Dispersant) | | | |
| Non ionic | Fatty acid ethanolamide | 7.18 | 11.31 |
| (Dispersant) | | | |
| Anionic | Ethoxylated phosphated alcohol | 4.10 | 6.47 |
| (Wetting agent) | | | |
| Preserving Agent | Bronopol/(CIT/MIT) | 0.30 | 0.27 |
| Antifoam | Polysiloxane | 0.15 | 0.13 |
| Pigment | Copper Phthalocyanine pigment | 33.34 | 59.14 |
| | (Pigment Blue 15.3) | | |
| Filler pigment | Barium sulphate | 33.34 | 0 |

### Process for Preparing Example Formulations:

All components except for the pigment were weighed into a 500 ml container and mixed at low speed on an HSD for 5 minutes using a 60 mm blade. The pigment was then added slowly to the mixture, whilst stirring at low speed continued.

When all the pigment was added, mixing was stopped and any dry material was scraped off the blade and the sides of the container. The mixture was then dispersed at 1000 rpm for 45 minutes yielding 500 g of tinter.

### Testing

### Pictorial Strength Test Method:

Standard black base (51) was made up using Dulux Trade Vinyl Matt Extra Deep Base (5537.9 g) and black tinter (115 g). This was shaken for 3 minutes to mix thoroughly.

10 g of test tinter (adjusted for pigment content) was added to 100 g of standard base and stirred with a palette knife until no streaks were visible. The paint was then shaken for 45 s and drawn down on a white merest chart with a K-bar no. 9.

The strength of each sample was measured against a standard paint containing 10 g of the standard.

### Adapted Zwick Tensile Test Method

8 g of the test tinter was weighed into a 30 ml GC headspace vial) [VWR 20 ml clear glass, 75.5×23 mm, Cat No 548-0055, Batch No.:20175

A piece of PVOH [Monosol M7031 (2 mls)] approximately 4 cm² was glued over the top of the vial opening using Bondmaster 2 pack epoxy adhesive.

The rubber septum was removed from a GC vial cap and the vial cap was clamped tightly onto the vial over the film leaving a circular piece of film approximately 1 cm diameter exposed.] [Headspace Aluminium crimp cap PTFE/Silicon septum, 20 mm, Agilent Technologies, Part Number:5183-4477, Lot:061375-7-1#]

The vial was inverted and left overnight in the controlled temperature room [23-24C]

The vial was then analyzed by Zwick Tensionometer, in compression mode, at ambient temperature, with the film circle being pierced by a 4 mm diameter cylindrical probe at a speed of 100 mm/min and the force required to do so was measured using a load cell.

The result was compared with a vial produced in exactly the same way without any tinter and the force as a percentage of standard was quoted as the final result. The figures for “Force N as % blank” are thus the aforesaid combined water and plasicizer activity of the film.

1. A tinter dosage unit comprising a water-borne tinter encapsulated in a water soluble pouch wherein the water activity of the tinter and the combined water activity and plasticizer activity of the pouch are such that the pouch remains intact in normal use.

2. The tinter dosage unit of claim 1 where wherein the pouch is formed from a water soluble film.

3. The tinter dosage unit of claim 2 wherein the water soluble film is selected from the group consisting of polyvinyl alcohols, polyvinyl acetates, polyvinyl pyrrolidones, poly carboxylic acids and their salts, polyacrylates, polyacrylamides, cellulose, cellulose ethers, cellulose esters, cellulose amides, polyacrylic acids and their salts, polyaminoacids and peptides, polyamides, copolymers of maleic and acrylic acids, and polysaccharides.

4. The tinter dosage unit of claim 2 wherein the water soluble film is a polyvinyl alcohol film.

5. The tinter dosage unit of claim 1 wherein the water activity of the tinter is from 0.1 to 1.00 inclusive.

6. The tinter dosage unit of claim 1 wherein the water activity of the tinter is at least 0.2.

7. The tinter dosage unit of claim 6 wherein the water activity of the tinter is no greater than 0.9.

8. The tinter dosage unit of claim 2 wherein the combined water and plasticizer activity of the film is from 20 to 110% inclusive.

9. The tinter dosage unit of claim 8 wherein the combined water and plasticizer activity is at least 40%.

10. The tinter dosage unit where of claim 9 wherein the combined water and the plasticizer activity is no more than 90%.

11. The tinter dosage unit of claim 1 wherein the tinter comprises a humectant and the humectant content is from 5 to 20% by weight of the tinter.

12. The tinter dosage unit of claim 1 wherein the tinter comprises an ionic surfactant and the surfactant is from 1 to 5% by weight inclusive of the tinter.

13. The tinter dosage unit claim 1 wherein the tinter has a maximum solids content of 80% by weight of the tinter.

14. The tinter dosage unit of claim 1 wherein the tinter comprises one or more coloured pigments and optionally one or more filler pigments.

15. The tinter dosage unit of claim 4 wherein the water activity of the tinter is from 0.1 to 1.00 inclusive.

16. The tinter dosage unit of claim 1 wherein the water activity of the tinter is no greater than 0.9.

17. The tinter dosage unit of claim 3 wherein the combined water and plasticizer activity of the film is from 20 to 110% inclusive.

18. The tinter dosage unit of claim 2 wherein the combined water and the plasticizer activity of the film is no more than 90%.

19. The tinter dosage unit of claim 10 wherein the tinter comprises a humectant and the humectant content is from 5 to 20% by weight of the tinter.

20. The tinter dosage unit of claim 5 wherein the tinter comprises an ionic surfactant and the surfactant is from 1 to 5% by weight inclusive of the tinter.
